(19) United States
(12) Patent Application Publication
(10) Pub. No.: US 2003/0207709 A1
(43) Pub. Date: Nov. 6, 2003

(54) Gaming machine

(76) Inventor: Pai Paotrakul, Kogarah (AU)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/136,252

(22) Filed: May 1, 2002

(51) Int. Cl. A63F 13/00

(52) U.S. Cl. 463/20

(57) ABSTRACT

A gaming machine adapted to display and operate a base game 10 (such as a spinning reel type poker machine), and a feature game 15. The operation of the feature game 15 does not rely on any triggering outcomes in the base game 10. The random occurrence of a predetermined trigger 16 in the feature 15 causes an adjustment to the outcome in the base game such as the substitution of particular symbols on the reels for wildcards.

### BACKGROUND OF THE INVENTION

The present invention relates to gaming machines. The invention has been developed primarily for computerized gaming machines and will be described herein with specific reference to that application. However, it will be appreciated that the invention is not limited to of that particular type of gaming machine.

Gaming machines have long been known and are now one of the most common forms of gambling. One of the oldest and best known forms of gaming machine is the rotating reel type “poker machine”. These machines use a series of three or more reels, each having symbols on their peripheral edge. The reels are rotated upon placing a bet and then stopped to produce a randomly selected arrangement of symbols. Winnings are paid if the random arrangement of symbols matches one of the predetermined winning combinations.

Recently these gaming machines have been computerized with a video display replacing the physically rotating reels. The display screen typically presents an array of symbols in five columns and three rows equating to the symbols that would normally be seen on the five rotating reels of the old style mechanical machines. Computerized machines have allowed players to bet on the symbols appearing in one or more rows or columns instead of just the line of symbols across the middle row, which was the traditional practice of the old style mechanical machines. Eventually, all the practical “paylines” of symbols available in the array were being used in computerized gaming machines.

In an ongoing effort to further enhance the gaming experience, gaming machines provided secondary games of a different nature to the primary game. The secondary games are often referred to as “features”. The feature would appear upon some trigger event such as a predetermined outcome in the primary game. By using a different type of feature game, the “volatility” can be easily varied to enhance the gaming experience.

The “volatility” of a gaming machine refers to the expected frequency of wins and the corresponding amount paid for each win. Over time, all gaming machines return a set percentage of the bets received as winnings. However, a machine with a high volatility will return this percentage through fewer wins of higher value than a low volatility machine which provides more wins of less value.

A feature with relatively high volatility will provide an opportunity for greater wins, which can make the game more exciting for the player. However, because of the higher volatility, the number of wins will usually be lower and this can generate negative player sentiment towards the feature. To address this, some gaming machines have “free” features. The feature is perceived to be free because the player does not place a bet once the trigger occurs, but will receive some form of reward from the feature anyway. The reward may be in the form of bonus games or simply extra credits.

Ideally, the free feature should give the player an escalating sense of anticipation and excitement. Unfortunately, if the trigger simply results in extra credits, the player is quickly aware of how many extra credits they receive without any sense of slowly escalating anticipation or excitement. Similarly, a series of free games can give the player some excitement at the outcome of each individual game, however the level of anticipation and excitement over the whole feature does not escalate to a peak.

Another disadvantage of free features is the frequency that they occur. If the free feature is likely to significantly increase the amount of winnings, the player gets a strong sense of bonus whenever it is triggered. However, a feature with a high probability of yielding generous returns can only occur infrequently in order to maintain the set percentage of bets retained by the machine over a long period of time. Therefore, prolonged periods without the occurrence of a trigger can produce a negative reaction in the player.

### SUMMARY OF THE INVENTION

In accordance with the present invention, there is provided a gaming machine which overcomes or ameliorates at least one of the disadvantages of prior gaming machines and provides a useful alternative.

Further, in accordance with the present invention, there is provided a gaming machine comprising: means adapted for displaying a game that has random outcomes, wherein the random outcomes include predetermined winning outcomes; means adapted for accepting a bet on the occurrence of at least one winning outcome; means adapted for paying winnings on the occurrence of any of the winning outcomes carrying a bet; and means adapted for displaying a feature that operates irrespective of the outcomes in the game, wherein the operation of the feature is random and wherein the outcome of the game is adjusted in response to a predetermined trigger event during the operation of the feature.

The feature is suitably designed so that its random operation and the trigger event are of a type that escalates player anticipation and excitement when the feature appears to be progressing towards a trigger event.

In a preferred form, the means adapted for displaying the game include a video screen on which an array of randomly selected symbols is displayed, the winning outcomes are predetermined winning combinations of symbols, and the outcome of the game is adjusted by substituting a wild card symbol for at least one of the symbols in the array.

The use of wildcards is well known in many different forms of gambling. It is a reference to a card or symbol that can substitute for any of the other available cards or symbols. It will be appreciated that the appearance of a wildcard in the array of symbols increases the probability of a winning combination.

In a further preferred form, the alteration to the outcome includes a single oversized wildcard symbol that substitutes for at least two adjacent symbols in the array.

An oversized wildcard symbol that occupies two or more adjacent sites in the array is particularly advantageous to the player because of the high number of paylines that will include the oversized wildcard. Furthermore, the appearance of a large single wildcard in the array has a strong visual impact and helps to reinforce the sense of bonus.

In a particularly preferred form, the oversized wildcard symbol suitably occupies an entire column of the array. In other preferred forms, the oversized wildcard symbol suitably increases the winnings normally paid for any winning combinations. In some embodiments the oversized wildcard symbol doubles the winnings normally paid for a winning combination or it may also triple the winnings normally paid.

Preferably, the feature involves an animation that takes a random path across the display screen and the trigger event occurs when the animation crosses at least one predetermined area in the display. The use of a meandering animated figure is visually dynamic and helps to maintain the player's interest. Furthermore, as the figure moves towards a designated trigger area, the player experiences an escalating sense of anticipation and excitement. In other preferred forms, the animation may be a simulated race between a set of competitors whereby the player selects a competitor to win the race and the trigger event occurs if the selected competitor does win. This embodiment will also provide an escalating sense of excitement and anticipation by configuring the animation to make the outcome of the simulated race uncertain until the completion of the race by keeping the competitors relatively close with the lead competitor changing several times.

In one example, the animation is suitably a lion that runs through the display screen in a random fashion and the trigger event occurs when the lion jumps through a flaming hoop positioned at a predetermined location on the screen. In another embodiment, the animation is suitably an eagle that flies around the display screen or any other suitable character or figure. The animation may appear at the conclusion of each single operational cycle of the game or it may be present on the screen while the game is operating.

These and other advantages, aspects, and features will be understood by one of ordinary skill in the art upon the reading and understanding of the specification.

### BRIEF DESCRIPTION OF THE DRAWINGS

An embodiment of the present invention will now be described by way of example only with reference to the accompanying drawings in which:

FIG. 1 shows part of the display screen of a gaming machine according to the present invention; and

FIG. 2 shows the adjusted outcome of the game.

### DETAILED DESCRIPTION OF THE PREFERRED EMBODIMENT

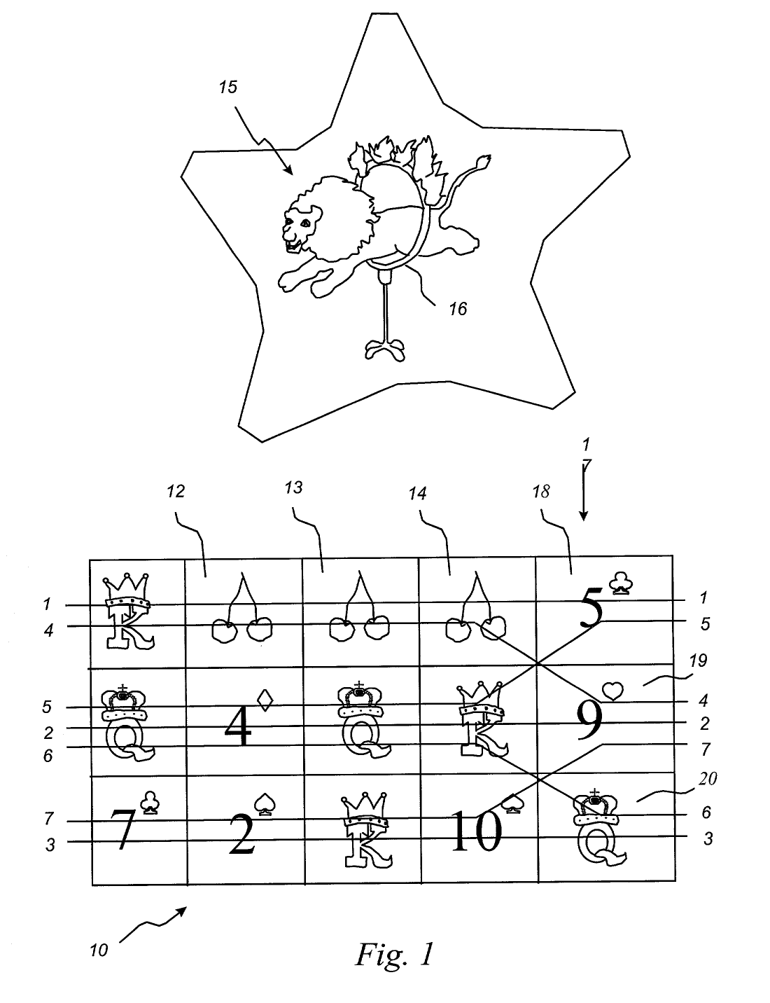

Referring to FIG. 1, the gaming machine display is a simulation of a five reel array 10 of symbols which is the typical format for computerized poker machines of the spinning reel type. The array 10 has paylines 1-1, 2-2, 3-3, 4-4, 5-5, 6-6, and 7-7 available for betting. The player can place a bet on one or more of the paylines and if the outcome of the game shows a winning combination of symbols along a payline carrying a bet, the machine awards the player predetermined winnings. The winnings for all the winning combinations are presented in a table (not shown) often referred to as a paytable. In the present example, three cherry symbols 12, 13 and 14 in any payline carrying a bet of 1 credit will win 20 credits. Hence the player would receive winnings for the outcome shown in FIG. 1 if payline 1-1 and/or payline 4-4 are carrying a bet.

In the present example, the operation of the feature initiates once the outcome of the base game has been established. The feature is an animation of a lion 15 which runs across the display screen in a random path. It can be restricted to a designated area of the screen or across the entire screen including the array of symbols 10. If the lion 15 enters a predetermined area of the screen showing a flaming hoop 16 symbol, the machine is programmed to show the lion 15 jumping through the hoop 16 in order to indicate to the player that the trigger event has occurred.

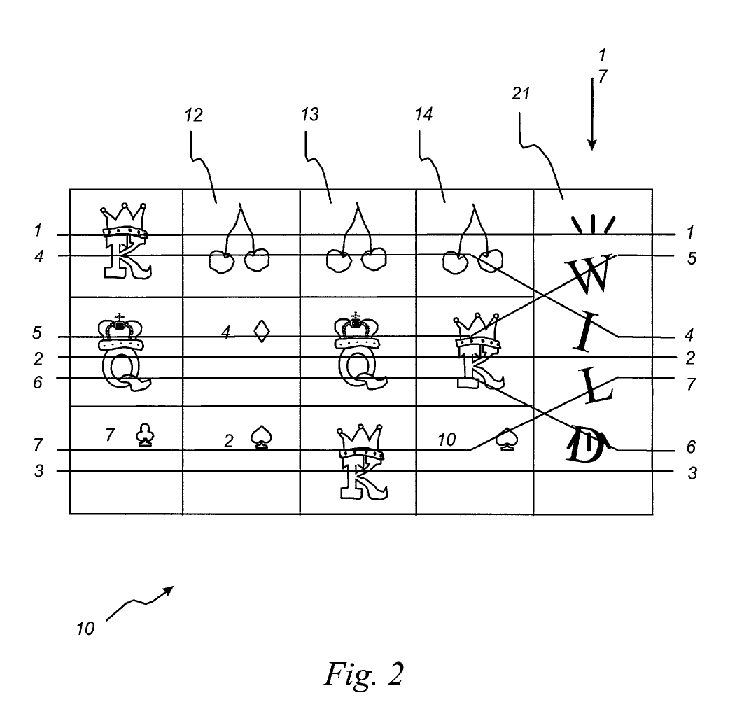

Referring to FIG. 2, the array of symbols 10 is shown after it has been adjusted in response to the trigger in the feature. The symbols 18, 19 and 20 that were originally in reel 17 of the array 10 have been substituted by an oversized wildcard symbol 21 which occupies all three symbol sites in the column. Every available payline intersects the oversized wildcard 21 which provides a strong incentive to place bets on all the available paylines to maximize winnings upon the appearance of the wildcard. For example, if the machine pays 50 credits upon the occurrence of four cherry symbols in any one payline, the player would receive 100 credits upon the appearance of the wildcard 21 if paylines 1-1 and 4-4 were carrying a bet of one credit each.

Playing all paylines also increases the profit from the machine. Players can place a single high value bet on a single payline but the natural tendency is to spread the bet over a number of paylines. Therefore playing all paylines tends to increase the total amount bet over time.

The appearance of a large wildcard symbol in the array has a significant visual impact which helps to reinforce the sense of bonus in the player. To further enhance this, the wildcard 21 is suitably also be configured to double or treble the normal winnings paid for any winning combinations on the paylines. This provides an even greater incentive for the player to place a bet on all available paylines.

This arrangement provides a gaming machine that maintains player interest with a highly visually dynamic feature that operates regardless of the outcome from the primary game. The feature still provides an escalating sense of anticipation and excitement by being able to move towards a trigger event, while keeping the player uncertain as to whether or not the animation will reach the trigger event. By maintaining the player's interest in this way, the trigger in the feature can occur less often than it would if it were in the primary game, thereby allowing the adjustment to the primary game to be more generous to the player.

The present invention has been described herein by way of example only. Persons skilled in the art will recognize many variations and modifications which do not depart from the spirit and scope of the broad inventive concept. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. A gaming machine comprising:
means adapted for displaying a game that has random outcomes, wherein the random outcomes include predetermined winning outcomes;
means adapted for accepting a bet on the occurrence of at least one winning outcome;
means adapted for paying winnings on the occurrence of any of the winning outcomes carrying a bet; and
means adapted for displaying a feature that operates irrespective of the outcomes in the game, wherein the operation of the feature is random and wherein the outcome of the game is adjusted in response to a predetermined trigger event during the operation of the feature.

2. A gaming machine according to claim 1 wherein the means adapted for displaying the game includes a video screen on which an array of randomly selected symbols is displayed, wherein the winning outcomes are predetermined winning combinations of symbols, and wherein the outcome of the game is adjusted by substituting a wild card symbol for at least one of the symbols in the array.

3. A gaming machine according to claim 2 wherein the adjustment is a single oversized wildcard symbol that substitutes for at least two adjacent symbols in the array.

4. A gaming machine according to claim 3 wherein the oversized wildcard symbol occupies an entire column of the array.

5. A gaming machine according to claim 4 wherein the oversized wildcard symbol increases the winnings normally paid for any winning combinations.

6. A gaming machine according to claim 5 wherein the oversized wildcard symbol doubles the winnings normally paid for a winning combination.

7. A gaming machine according to claim 5 wherein the oversized wildcard symbol triples the winnings normally paid for a winning combination.

8. A gaming machine according to claim 1 wherein the feature comprises an animation that takes a random path across the display and wherein the trigger event occurs when the animation crosses at least one predetermined area in the display.

9. A gaming machine according to claim 8 wherein the animation is a simulated race between a set of competitors whereby the player selects a competitor to win the race and wherein the trigger event occurs if the selected competitor wins the race.

10. A gaming machine according to claim 8 wherein the animation is a lion that runs through the display screen in a random fashion and wherein the trigger event occurs when the lion jumps through a flaming hoop positioned at a predetermined location on the screen.

11. A gaming machine according to claim 8, wherein the animation is a character which flies around the display screen.

12. A gaming machine according to claim 8 wherein the animation appears at the conclusion of each single operational cycle of the game.

13. A gaming machine according to claim 8 wherein the animation is present on the screen whenever the game is operating.

14. A method for operating a gaming machine comprising:
displaying a game that has random outcomes, wherein the random outcomes include predetermined winning outcomes;
accepting a bet on the occurrence of at least one winning outcome;
paying winnings on the occurrence of any of the winning outcomes carrying a bet; and
displaying a feature that operates irrespective of the outcomes in the game, wherein the operation of the feature is random and wherein the outcome of the game is adjusted in response to a predetermined trigger event during the operation of the feature.

15. A method according to claim 14 wherein the game comprises displaying an array of randomly selected symbols on a video screen, wherein the winning outcomes are predetermined winning combinations of symbols, and wherein the outcome of the game is adjusted by substituting a wild card symbol for at least one of the symbols in the array.

16. A method according to claim 15 wherein the adjustment is a single oversized wildcard symbol that substitutes for at least two adjacent symbols in the array.

17. A method according to claim 16 wherein the oversized wildcard symbol occupies an entire column of the array.

18. A method according to claim 17 wherein the oversized wildcard symbol increases the winnings normally paid for any winning combinations.

19. A method according to claim 18 wherein the oversized wildcard symbol doubles the winnings normally paid for a winning combination.

20. A method according to claim 18 wherein the oversized wildcard symbol triples the winnings normally paid for a winning combination.

21. A method according to claim 14 wherein the feature comprises an animation that takes a random path across the display and wherein the trigger event occurs when the animation crosses at least one predetermined area in the display.

22. A method according to claim 21 wherein the animation is a simulated race between a set of competitors whereby the player selects a competitor to win the race and wherein the trigger event occurs if the selected competitor wins the race.

23. A method according to claim 21 wherein the animation is a lion that runs through the display screen in a random fashion and wherein the trigger event occurs when the lion jumps through a flaming hoop positioned at a predetermined location on the screen.

24. A method according to claim 21 wherein the animation is a character which flies around the display screen.

25. A method according to claim 21 wherein the animation appears at the conclusion of each single operational cycle of the game.

26. A method according to claim 21 wherein the animation is present on the screen whenever the game is operating.
